(19) United States
(12) Patent Application Publication
(10) Pub. No.: US 2025/0208354 A1
(43) Pub. Date: Jun. 26, 2025

(54) Waveguide-Grating Coupler Comprising a Vertically Tapered Region

(71) Applicant: LioniX International BV, Enschede (NL)

(72) Inventors: Christos KOULOUMENTAS, Agia Paraskevi (GR); Lefteris GOUNARIDIS, Kipseli (GR); Philip Paul Joao SCHRINNER, Ahaus (DE); Panagiotis GKROUMAS, Peristeri (GR)

(21) Appl. No.: 18/999,699

(22) Filed: Dec. 23, 2024

Related U.S. Application Data
(60) Provisional application No. 63/613,393, filed on Dec. 21, 2023.

(51) Int. Cl. G02B 6/34; G02B 26/10; G02B 27/10

(52) U.S. Cl. CPC G02B 6/34; G02B 26/106; G02B 27/1086

(57) ABSTRACT

A grating coupler includes a grating element that has a scattering strength that increases smoothly along its length from a very weak scattering strength at its leading edge to a strong scattering strength where the grating element ends. The grating element comprises the top stripe of a dual-stripe waveguide portion, where the light signal introduced to the grating is confined to only the bottom stripe of the waveguide outside the region of the grating element. In the grating-element region, the top stripe has a thickness that increases from zero to its full desired thickness over a long length, thereby defining an small taper angle that gives rise to an output beam having a large, substantially Gaussian-shaped (or Bessel-Gaussian) beam waist along the length of the grating element.

### TECHNICAL FIELD

The present disclosure relates to integrated optics in general and, more specifically, to waveguide-based vertical-coupling elements for emitting light into free space.

### BACKGROUND

A Planar Lightwave Circuit (PLC) is an optical system comprising one or more integrated-optics-based waveguides that are disposed on the surface of a substrate, where the waveguides are typically combined to provide complex optical functionality. These “surface waveguides” (referred to hereinafter simply as “waveguides”) typically include a core of a first material that is surrounded by a cladding comprising a second material having a refractive index that is lower than that of the first material. The change in refractive index at the interface between the materials enables internal reflection of light propagating through the core, thereby guiding the light along the length of the surface waveguide.

In many applications, it is desirable to launch optical energy propagating through a waveguide vertically out of the waveguide into free space. Historically, this has been realized by integrating a “vertical-grating coupler” (hereinafter referred to simply as a “grating coupler”) formed in the waveguide structure, where the grating structure is configured to scatter optical energy out of the waveguide in a vertical direction.

In the prior-art, grating couplers have been predominantly used on an individual basis to optically couple a light signal in a single waveguide to or from an external device, such as a source, detector, sensor, or optical fiber. As a result, a conventional grating coupler is typically designed with a very short focal length and small beam diameter to optimize coupling efficiency in such applications.

In some cases, however, a plurality of grating couplers has been used to form an optical-phased array (OPA), in which the emissions from the individual grating couplers collectively define at least one composite output beam that propagates out of the plane of the array. The output beam(s) can be independently steered in two angles by (1) controlling the phases of the light emitted from different grating couplers and (2) controlling the wavelength of the light presented to the gratings of the array.

The longitudinal range (i.e., maximum distance at which objects can be detected) of such beam-steering systems depends on the focal length and beam waist of the emitted light from each of its grating couplers. Unfortunately, as noted above, conventional grating couplers are normally optimized for coupling to an optical fiber (or other external component) such that they typically have a very short focal length and small beam waist. As a result, grating-coupler-based beam-beam steering systems have required the inclusion of costly and complex additional bulk optics, such as lenses, to realize a useful operating range. As will be apparent to one skilled in the art, however, the inclusion of such bulk optics limits the scalability of such assemblies.

Furthermore, prior-art grating couplers that efficiently scatters light into free space typically requires many fabrication steps, increasing production cost, reducing yield, and adding complexity.

A grating coupler that can efficiently provide a large beam waist and is suitable for use in a cost-effective OPA would be a welcome advance in the state of the art.

### SUMMARY

The present disclosure is directed toward vertical-grating couplers having large beam waists that offer significant advantages when used in optical-phased array applications. Grating couplers in accordance with the present disclosure are particularly well suited for use in beam-steering systems for Light Detection and Ranging (LiDAR) applications, broadcasting, space probe communications, satellite communications, human machine interfaces, trapped-ion or neutral-atom quantum systems, and the like.

Like the prior art, grating couplers in accordance with the present disclosure scatter light propagating through a waveguide into free space by means of a grating structure that is operatively coupled with the waveguide.

In sharp contrast to the prior art, a grating coupler in accordance with the present disclosure includes a relatively long grating element that has a scattering strength that increases smoothly along its length from a very weak scattering strength at its leading edge to a strong scattering strength where the grating element ends. This is achieved by forming the grating element in just the top stripe of a dual-stripe waveguide portion, where the light signal introduced to the grating is confined to only the bottom stripe of the waveguide outside the region of the grating element. In the grating-element region, the top stripe has a thickness that increases from zero to its full desired thickness over a long length, thereby defining an extremely small taper angle that gives rise to an output beam having a large, substantially Gaussian-shaped (or Bessel-Gaussian) beam waist along the length of the grating element. Grating couplers in accordance with the present disclosure, therefore, mitigate the need for external optics to realize operating ranges as long as tens of meters.

An illustrative embodiment is a grating coupler formed in a silicon nitride waveguide disposed on a substrate. Outside the area of the grating coupler, the waveguide has a single-layer core comprising a first layer of silicon nitride. In the area of the grating coupler, an upper core is disposed on a central core disposed on a lower core, thereby defining a multi-core waveguide. The upper core is a second layer of silicon nitride, the central core is a thin layer of silicon dioxide, and the lower core is the first layer of silicon nitride.

The grating element of the grating coupler is formed in just the upper core, which has a thickness that transitions from zero at the leading edge of the grating coupler to its full design thickness at its termination. As a result, the incoming light signal is confined only in the bottom stripe at the leading edge, but slowly interacts more strongly with the emerging grating in the upper core as it propagates through the grating element. The taper angle of the grating element is selected such that the grating coupler scatters the incoming light signal into an output beam having a large, substantially Gaussian-shaped (or nearly Gaussian-shaped or Bessel-Gaussian) beam waist with low divergence along its longitudinal axis but is highly divergent in the lateral direction.

In some embodiments, an array of grating couplers is formed in a network of silicon-nitride-based waveguides on a substrate. The grating couplers are arranged to define an OPA that generates an output beam that can be scanned through three-dimensional space. In some embodiments, additional optics are positioned over the OPA to control beam shape and/or facilitate a large scanning range in at least one dimension.

### BRIEF DESCRIPTION OF THE DRAWINGS

FIG. 1 depicts a schematic drawing of a cross-sectional view of a vertical-grating coupler in accordance with the present disclosure.

FIG. 2 depicts operations of a method suitable for forming a grating coupler in accordance with the present disclosure.

FIG. 3A depicts a schematic drawing of a cross-sectional view of nascent grating coupler 100′ after the formation of mask layer 308.

FIG. 3B depicts a schematic drawing of a cross-sectional view of nascent grating coupler 100′ during operation 204.

FIG. 3C depicts a schematic drawing of a cross-sectional view of nascent grating coupler 100′ after operation 205.

FIG. 4 depicts a schematic drawing of a perspective view of the emission from grating coupler 100 in response to receipt of light signal 116.

FIG. 5 depicts a schematic drawing of a top view of a light scanner suitable for use in a LiDAR system in accordance with the present disclosure.

FIG. 6 depicts a schematic drawing of a top view of an alternative light scanner in accordance with the present disclosure.

FIG. 7 depicts a schematic drawing of a cross-sectional view of an alternative vertical-grating coupler in accordance with the present disclosure.

### DETAILED DESCRIPTION

It is an aspect of the present disclosure that, for many applications, it is desirable to scatter light from a grating coupler such that the scattered light has a very large beam waist with low beam divergence along the direction aligned with the longitudinal axis of the grating coupler. At the same time, it can be particularly beneficial to scatter the light such that it has large beam divergence laterally (i.e., orthogonal to the longitudinal axis). These attributes are particularly attractive for applications in which arrays of such grating couplers are employed such that they operate in a cooperative manner to generate at least one output light beam that can be steered about three-dimensional space by varying the wavelength of light provided to the grating couplers and/or controlling the relative phases of the light emitted by the grating couplers.

Grating couplers in accordance with the present disclosure are characterized by design criteria that include:
i. weak scattering strength; or
ii. long length; or
iii. well-controlled wavelength dependence of a deflection angle in a first plane defined by the longitudinal axis of the grating and the normal vector of the grating; or
iv. large beam divergence in a second plane that is orthogonal to the first plane and the longitudinal axis of the grating coupler; or
v. any combination of i, ii, iii, and iv.

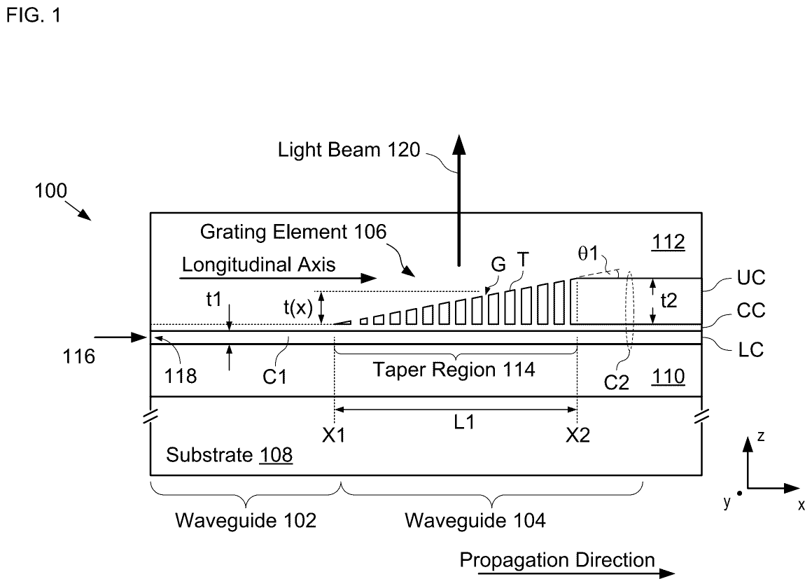

FIG. 1 depicts a schematic drawing of a cross-sectional view of a vertical-grating coupler in accordance with the present disclosure. Grating coupler 100 includes waveguides 102 and 104 and grating element 106, all of which are disposed on conventional substrate 108.

Waveguide 102 is a conventional surface waveguide comprising core C1, which is disposed between conventional cladding layers 110 and 112. In the depicted example, core C1 includes a single layer of stoichiometric silicon nitride having thickness t1, which is selected to enable single-mode propagation of light signal 116. Light signal 116 is received by waveguide 102 at port 118. In some embodiments, core C1 includes a material other than stoichiometric silicon nitride and/or has a different thickness (e.g., a thickness that enables multimode propagation of a light signal) and/or includes multiple cores.

In the depicted example, cladding layers 110 and 112 are silicon oxide layers; however, any suitable material can be used for cladding layers 110 and/or 112, including air.

Waveguide 104 is a multi-layer-core surface waveguide comprising core C2 and cladding layers 110 and 112. Waveguide 104 is an example of a TriPleX™ waveguide, examples of which are described in detail in U.S. Pat. Nos. 7,146,087 and 7,142,759, each of which incorporated herein by reference.

Core C2 includes lower core LC, central core CC, and upper core UC.

Lower core LC is the region of core C1 located within the structure of grating element 106.

Central core CC is a thin layer of stoichiometric silicon dioxide and has a thickness that does not substantially perturb the optical mode of light propagating through waveguide 104. In the depicted example, central core CC has a thickness of approximately 100 nm; however, a wide range of thicknesses can be used for central core CC without departing from the scope of the present disclosure.

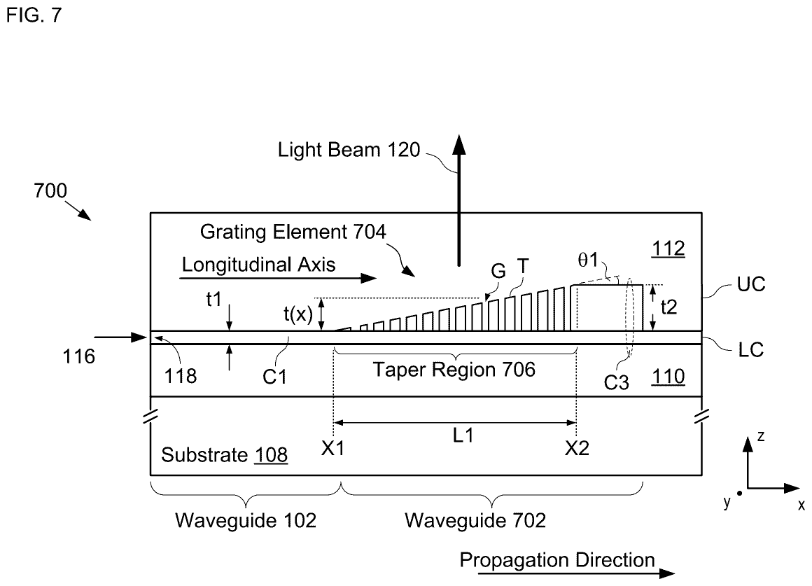

Upper core UC is another layer of stoichiometric silicon nitride having thickness t2, which is chosen based on the thicknesses of lower core LC and central core CC. Lower core LC, central core CC, and upper core UC are configured such that the three layers can collectively guide the mode field of light signal 116. As discussed below with respect to FIG. 7, in some embodiments, central core CC is non-existent throughout the grating coupler and upper core UC is disposed directly on lower care LC.

Grating element 106 is defined in taper region 114 of waveguide 104 and is configured to effectively scatter the optical energy of light signal 116 into free space as light beam 120.

Taper region is a region of upper core UC that extends from location X1 to location X2, which the thickness of the upper core is tapered by angle θ1 along the length from such that it changes monotonically from zero to t2. In the depicted example, the thickness profile t(x) of grating element 106 increases linearly from X1 to X2; however, in some embodiments, the thickness profile is other than linear, such as sinusoidal, piecewise linear, non-linear, curved, irregular, monotonically changing, non-monotonically changing, exponential, and the like.

Tapered regions suitable for use in grating coupler 100 and methods for forming them are described in detail in U.S. Pat. Nos. 8,718,432, 9,268,089, 9,929,582, and 9,020,317, each of which is incorporated herein by reference.

As discussed below, tapered region 114 includes teeth, T, and gaps, G, which collectively define grating element 106 in only upper core UC. The height of teeth T increases slowly along the length of grating element 106, which gives rise to a slowly increasing scattering strength along the longitudinal axis of the grating element. This enables grating coupler 100 to efficiently scatter optical energy of light signal 116 into light beam 120 such that the light beam has a large, nearly Gaussian-shaped (or Bessel-Gaussian) beam waist and small beam divergence along the direction of propagation, which is aligned with the longitudinal axis.

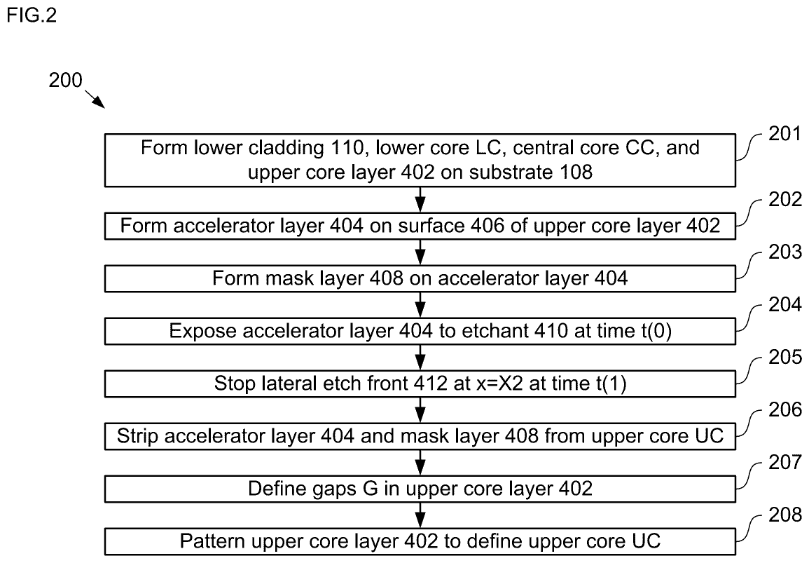

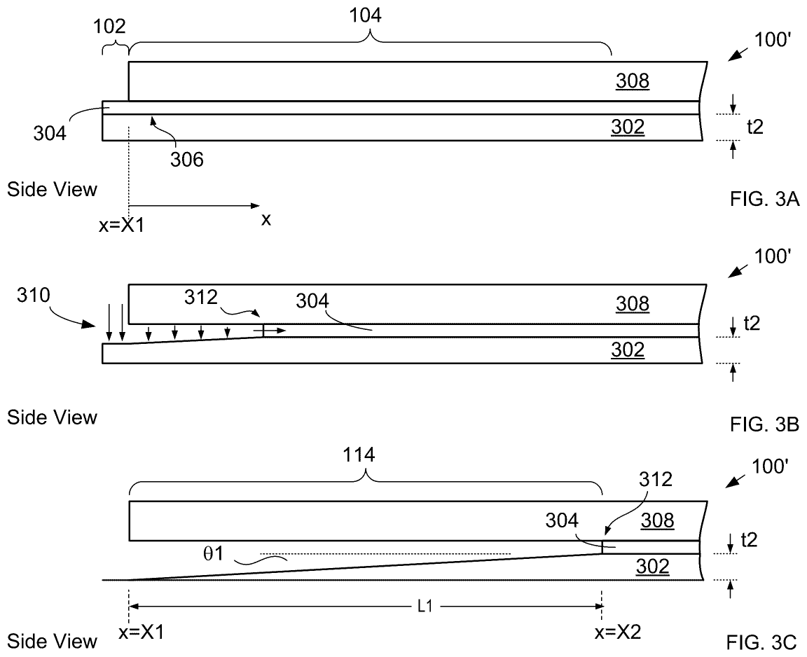

FIG. 2 depicts operations of a method suitable for forming a grating coupler in accordance with the present disclosure. Method 200 is described with continuing reference to FIG. 1 and reference to FIGS. 3A-C.

Method 200 begins with operation 201, wherein lower cladding 110, lower core LC, central core CC, and upper core layer 302 are formed on substrate 108.

Upper core layer 302 is a layer of stoichiometric silicon nitride having thickness t2.

At operation 202, accelerator layer 304 is formed on surface 306 of upper core layer 302.

At operation 203, mask layer 308 is formed on accelerator layer 304. Mask layer is defined such that the accelerator layer is exposed in the region of waveguide 102 but protected in the region of waveguide 104.

FIG. 3A depicts a schematic drawing of a cross-sectional view of nascent grating coupler 100′ after the formation of mask layer 308.

At operation 204, accelerator layer 304 is exposed to etchant 310 in the region of waveguide 102 at time T(0).

Etchant 310 comprises a chemical (e.g., nitric acid, etc.) that etches the material of accelerator layer 304 at a desired etch rate relative to the rate at which it etches the material of upper core layer 302. As a result, accelerator layer 304 is removed above waveguide 102 and etchant 310 begins to attack the now exposed underlying upper core layer 302 uniformly in this region. Simultaneously, etchant 310 begins to etch accelerator layer 304 laterally under mask layer 308, forming lateral etch front 312, which travels along the z-direction from x=X1 toward x=X2, exposing surface 306 as it proceeds along the x-direction. In some embodiments, accelerator layer 304 is removed from a portion of the region of waveguide 102 via a different etch (e.g., a directional reactive-ion etch) that removes its material selectively over the material of upper core layer 302. This ensures a clean starting condition for the lateral etching of accelerator layer 304 in taper region 114. It can also improve the uniformity of the vertical etching of upper core layer 302 above waveguide 102. During operation 204, etch front 312 moves along the x-direction at a substantially constant velocity, thus the portion of surface 306 exposed to etchant 310 increases linearly with time.

FIG. 3B depicts a schematic drawing of a cross-sectional view of nascent grating coupler 100′ during operation 204.

Etch front 312 moves along the x-direction at a substantially constant velocity, thus exposing a linearly increasing amount of surface 306.

At operation 205, the etching of top core layer 402 by etchant 310 is stopped at time T(1). Time T(1) is selected based on the etch rate of the material of top core layer 402 in etchant 310, thickness, t2, of top core layer 402, and the desired length, L1, of taper region 114 (i.e., the desired taper angle θ1).

It should be noted that the magnitude of the taper angle, θ1, is dependent upon the relative etch rates of the materials of accelerator layer 404 and top core layer 402 in etchant 310. The relationship between θ1 and these etch rates can be described as:

$$θ 1 = {tan}^{- 1} \frac{E R 1}{E R 2} ,$$

where ER1 is the etch rate of the material of top core layer 402 and ER2 is the etch rate of the material of accelerator layer 404 in etchant 310.

FIG. 3C depicts a schematic drawing of a cross-sectional view of nascent grating coupler 100′ after operation 205.

At operation 206, accelerator layer 404 and mask layer 408 are stripped from the nascent grating coupler.

At operation 207, upper core layer 402 is patterned to define gaps G in taper region 114.

At operation 208, upper core layer 402 is patterned to define the shape of upper core UC.

At operation 209, cladding layer 112 is formed to complete grating coupler 100.

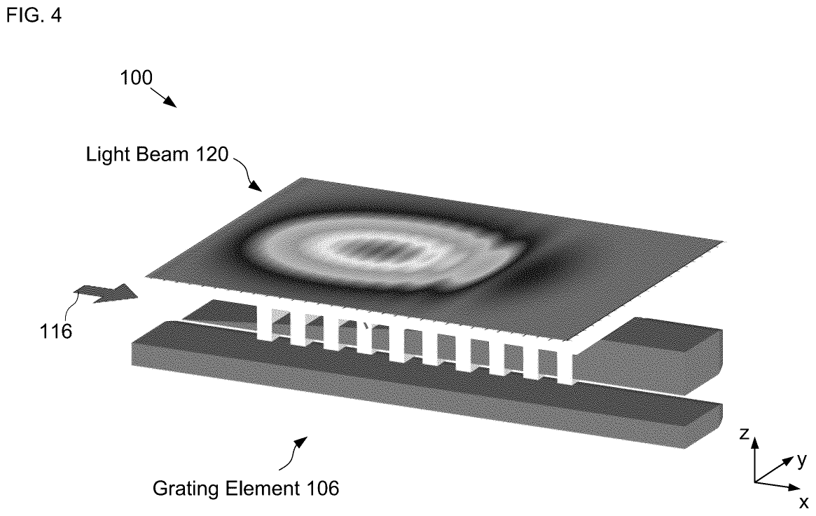

FIG. 4 depicts a schematic drawing of a perspective view of the emission from grating coupler 100 in response to receipt of light signal 116.

In the depicted example, L1 is 1250 microns, the wavelength of light signal 116 is 810 nm, period A is 527 nm, DC is 50%, and (for a thickness t2 of 0.175 micron) the taper angle, θ1, of grating element 106 is approximately 0.008°, which provides light beam 120 with a beam waist along the direction of propagation (i.e., the x-direction, as shown) that is on the order of millimeters in diameter, as well as very small beam divergence in this direction. In many applications, such as LiDAR, this affords significant advantages. For example, the range of a LiDAR system can be extended to tens of meters when grating elements in accordance with the present disclosure are employed, thereby mitigating the need for additional optics, such as lenses, as well as simplifying packaging and design constraints.

In some embodiments, waveguides 102 and 104 have a width (i.e., dimension in the y-direction as shown) that is on the order of the wavelength (e.g. 1 um). Such a configuration enables dense packaging and large lateral divergence. In some embodiments, waveguide width varies along the propagation direction to function as a lateral taper to, for example, enable light signal 116 to remain single mode. Furthermore, in some embodiments, waveguide width varies along the direction of propagation according to a periodic function to enhance the scattering profile of grating element 106.

It should be noted that the design parameters for grating 100 provided here are merely exemplary and any and all of these design parameters can have any practical value without departing from the scope of the present disclosure.

Furthermore, grating element 106 is preferably configured to provide sufficient chromatic dispersion to enable wavelength-dependent steering for controlling the direction of light beam 120 in the x-z plane.

At the same time, divergence of light beam 120 in the lateral direction (y-direction as shown) is also large (preferably much larger than its divergence in the longitudinal direction. In some embodiments, lateral beam divergence is greater than 20°; however, any lateral divergence that is significantly larger than a light beams longitudinal divergence can be used without departing from the scope of the present disclosure. This has significant advantages in some applications, such as those requiring cooperative operation of arrays of grating couplers, such as OPA applications. As discussed below, the large divergence in the lateral direction enables strong interaction in the far field between the emission patterns of adjacent gratings, thereby facilitating steering of light beam 120 in the y-z plane.

Although, in the depicted example, light beam 120 has a substantially elliptical cross-section, in some embodiments, a lateral taper is included in taper region 100 to generate a substantially circular output light beam having a large (˜mm sized) beam profile.

As discussed above, embodiments in accordance with the present disclosure are particularly well suited for use in optical phased arrays due to their large lateral beam divergence. OPA applications for grating couplers disclosed herein include LiDAR, broadcasting, space probe communications, satellite communications, human-machine interfaces, and the like.

It should be noted that the ability to independently scan light beam 120 in the x-z and y-z planes makes OPA based on grating couplers such as grating coupler 100 extremely attractive in many cases. However, it should be further noted that grating couplers in accordance with the present disclosure are also attractive for use in non-scanning applications that, for example, require a large packaging tolerance, such as chip-to-chip optical communications systems, and the like. In some such applications, it is particularly beneficial for a non-scanning beam to have a substantially more circular shape to provide large packaging tolerance in both lateral directions. This can be achieved with an additional lateral taper to a single grating or a passive splitting tree connected to a grating array, which results in a 2D Gaussian or Bessel-Gaussian beam shape.

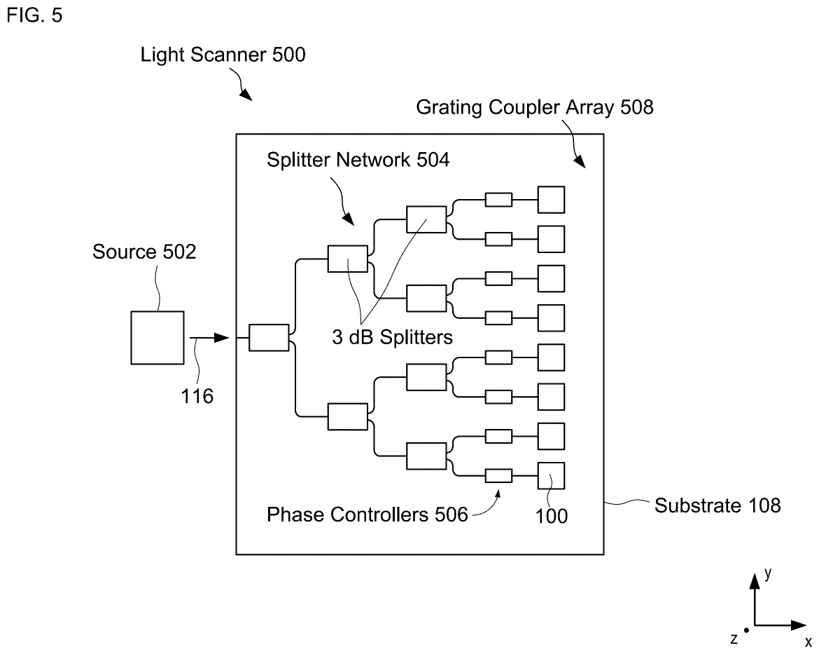

FIG. 5 depicts a schematic drawing of a top view of a light scanner suitable for use in a LiDAR system in accordance with the present disclosure. Light scanner 500 includes source 502, splitter network 504, phase controllers 506, and grating coupler array 508.

Source 502 is a tunable laser suitable for providing light signal 116 and controlling its wavelength over a desired spectral range. In some embodiments, source 502 comprises a different tunable light source. In some embodiments, source 502 is integrated on substrate 108. In some embodiments, source 502 and grating coupler 100 are joined via hybrid assembly techniques.

Splitter network 504 is a network of surface waveguides and 3 dB splitters that are collectively configured to distribute light signal 116 into N substantially equal intensity light-signal portions with an equal and stable phase front. In the depicted example, N=8; however, N can have any practical value without departing from the scope of the present disclosure.

Splitter network 504 provides a different light-signal portion to each of N phase controllers 506. Preferably, each phase controller 506 is operative for controlling the phase of its respective light-signal portion over at least 17 radians.

Each phase controller 506 is optically coupled with a different grating coupler of grating coupler array 508.

Grating coupler array 508 is a linear array of grating couplers 100.

In operation, grating coupler array 508 produces a composite output beam comprising light emitted from each grating coupler 100 in the array. In the depicted example, the composite output beam has a substantially elliptical shape. In some embodiments, an external optical element (e.g., a cylindrical lens) is positioned above grating coupler array 508 to further define the shape of the composite output beam (e.g., to convert its cross-section from elliptical to circular, increase the angular or transversal range of a grating coupler array, etc.).

To steer the angle of the composite output beam in the y-z plane, phase controllers 506 control the phase of the light-signal portion provided to each grating coupler 100 of grating coupler array 508.

To steer the angle of the composite output beam in the x-z plane, the wavelength of light signal 116 is controlled by controlling source 502.

Although the depicted example includes a linear array of grating couplers for producing an output beam, in some embodiments, a grating coupler array having more than one grating coupler per row is employed. In some such embodiments, a grating coupler array is an N×N “regular” array of equally spaced grating couplers 100. In some such embodiments, the grating coupler array is a non-regular array of M×N grating couplers, where M is not equal to N and each of M and N has any practical value. In some embodiments, at least two rows of grating couplers of a grating coupler array include different numbers of grating couplers. These arrangement can be particular useful to generate Bessel-Gaussian beam with an even longer working distance.

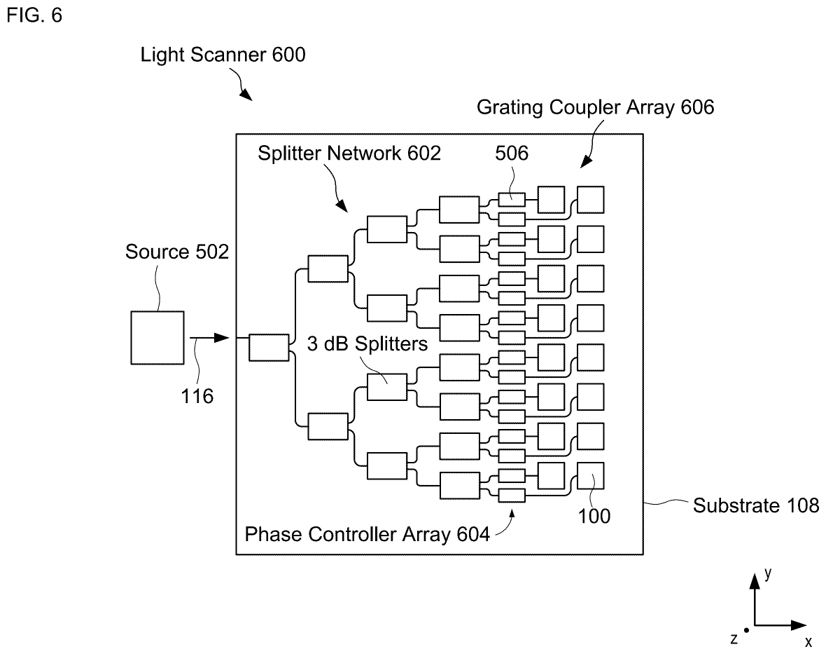

FIG. 6 depicts a schematic drawing of a top view of an alternative light scanner in accordance with the present disclosure. Light scanner 600 includes source 502, splitter network 602, phase controller array 604, and grating coupler array 606.

Splitter network 602 is analogous to splitter network 504; however, splitter network 602 includes an additional stage of 3 dB splitting to produce 16 substantially equal intensity light-signal portions.

Phase controller array 604 includes 16 phase controllers 506, each of which is operative for controlling the phase of the respective light-signal portion it receives over at least 171 radians.

Grating coupler array 508 is an M×N array of grating couplers 100. In the depicted example, M=2 and N=8; however, either of M and N can have any practical value without departing from the scope of the present disclosure.

In similar fashion to grating coupler array 508, grating coupler array 606 produces a composite output beam comprising light emitted from each grating coupler 100.

Like grating coupler array 508, the angle of the composite output beam is steered in the y-z plane by controlling the relative phases of the light-signal portions provided to phase controller array 604. In contrast to grating coupler array 508, however, the angle of the composite output beam in the x-z plane can also be steered by controlling the relative phases of the light-signal portions provided to the grating couplers in the different columns of phase controller array 604.

Although the depicted example of grating coupler 100 includes a multi-core waveguide having two nitride core layers separated by a thin oxide core layer, the principles of the teachings of the present disclosure can be applied to nearly any waveguide structure without departing from its scope. For example, in some embodiments, a grating coupler can be defined in a single-core waveguide.

FIG. 7 depicts a schematic drawing of a cross-sectional view of an alternative vertical-grating coupler in accordance with the present disclosure. Grating coupler 700 includes waveguides 102 and 702 and grating element 704, all of which are disposed on conventional substrate 108.

Grating coupler 700 is analogous to grating coupler 100; however, in grating coupler 700, waveguide 704 does not include central core CC (i.e., core C3 includes only lower core LC and upper core UC).

As a result, taper region 706 is formed directly on waveguide 102 such that it defines grating element 704 such that it has a thickness that increases from t1 to t1+t2 along length L1.

It is to be understood that the disclosure teaches just some examples of embodiments in accordance with the present invention and that many variations of embodiments in accordance with the present disclosure can easily be devised by those skilled in the art after reading this disclosure and that the scope of the present invention is to be determined by the following claims.

What is claimed is:

1. A vertical grating coupler, comprising:
a substrate;
a lower cladding layer disposed on the substrate;
an upper cladding layer disposed over the lower cladding layer;
a first planar waveguide that includes a first portion of a first core layer disposed between the upper and lower cladding layers;
a second planar waveguide having a multicore structure that includes a second portion of the first core layer and an upper core layer, the second planar waveguide including a taper region that defines a demarcation between the first and second portions of the first core layer;
a grating element defined in the taper region of the second planar waveguide, the grating element being configured to scatter optical energy into a free-space light beam in a direction orthogonal to a plane in which the substrate extends;
wherein the second portion of the first core layer extends below the grating region defined in the upper core layer.

2. The vertical grating coupler of claim 1 herein the grating element has a taper profile that increases scattering strength along a longitudinal axis of the grating element. Wherein the grating element has a thickness profile that increases linearly along a light propagation direction.

3. The vertical grating coupler of claim 1 herein the grating element has a thickness profile that increases non-linearly along a light propagation direction.

4. The vertical grating coupler of claim 1 wherein the grating element is configured to provide sufficient chromatic dispersion to enable wavelength-dependent steering of the free-space light beam.

5. The vertical grating coupler of claim 1 wherein the grating element is configured to provide the free-space light beam with a divergence in a light propagation direction that is less than a divergence in a longitudinal direction that is orthogonal to the light propagation direction.

6. The vertical grating coupler of claim 1 wherein the second planar waveguide includes a central core layer disposed below the upper core layer and above the first core layer.

7. The vertical grating coupler of claim 6 wherein the second core layer includes SiO2.

8. The vertical grating coupler of claim 1 wherein the first core layer includes SiN.

9. The vertical grating coupler of claim 1 wherein the upper core layer includes SiN.

10. A method of forming a vertical grating coupler, comprising:
forming a lower cladding layer on a substrate, a lower core layer over the lower cladding layer, and an upper core layer over the lower core layer;
forming an accelerator layer on a surface of the upper core layer;
forming a mask layer over a portion of the accelerator layer that is disposed over a second portion of the lower core layer but not a first portion of the lower core layer that extends laterally from the second portion;
exposing the accelerator layer to an etchant that etches the accelerator layer and the upper core layer at different rates to remove a portion of the accelerator layer disposed over the first portion of the lower core layer and etches a taper portion of the upper core layer disposed over the second portion of the lower core layer so that the taper portion of the upper core layer has a tapered thickness profile with a specified length and taper angle;
removing the accelerator layer and the mask layer;
patterning the upper core layer to form gaps in the taper portion of the upper core layer to thereby define a tapered grating element.

11. A light scanner, comprising:
a light source for providing a light signal;
a splitter network having a network of planer waveguides and optical splitters configured to distribute the light signal into a plurality of light signal portions equal in intensity;
a first plurality of phase controllers each receiving a different one of the light signal portions, each of the phase controllers being configured to control a phase of its respective light signal portion;
a first plurality of grating couplers each optically coupled to a different one of the phase controllers such that the first plurality of grating couplers produces a composite, free space, optical output beam emitted in a direction orthogonal to a plane in which the substrate extends, the composite, free space, optical output beam comprising light by each of the grating couplers in the first plurality of grating couplers, wherein at least one of the grating couplers is of the type set forth in claim 1.

12. The light scanner of claim 11 wherein the splitter network, the plurality of phase controllers and the plurality of grating couplers are formed on a common substrate.

13. The light scanner of claim 11 wherein the grating couplers in the first plurality of grating couplers are arranged in a linear array.

14. The light scanner of claim 11 further comprising a second plurality of phase controllers and a second plurality of grating couplers, the phase controllers in the second plurality each receiving a different one of the light signal portions and each of the grating couplers in the second plurality being optically coupled to a different one of the second phase controllers.

15. The light scanner of claim 14 wherein the grating couplers in the first plurality of grating couplers and the second plurality of grating couplers are arranged in a two-dimensional array.

16. A vertical grating coupler, comprising:
an optical coupler having first and second optical waveguides that overlap one another in a coupling region; and
a tapered grating defined in the coupling region of the first optical waveguide.
